(19) United States
(12) Patent Application Publication
(10) Pub. No.: US 2008/0312055 A1
(43) Pub. Date: Dec. 18, 2008

(54) Method of Obtaining a Continuous Mesh Tube Which is Used to Produce Bags for Vegetable and Fruit Products or Similar Products

(75) Inventor: Juan Carlos De Clasca Cabre, Badalona (ES)

Correspondence Address: MERCHANT & GOULD PC, P.O. BOX 2903, MINNEAPOLIS, MN, 55402-0903, US

(73) Assignee: PREFORMADOS TUBULARES, S.L., Badalona (ES)

(21) Appl. No.: 11/994,552

(22) PCT Filed: Jul. 6, 2006
(86) PCT No.: PCT/ES2006/000389

§ 371 Date: Aug. 5, 2008

(30) Foreign Application Priority Data
Jul. 6, 2005 (ES) P200501645

(51) Int. Cl. B31B 41/60

(52) U.S. Cl. 493/189

(57) ABSTRACT

The present invention relates to improvements introduced in invention patent number 200102600 relating to a process for obtaining a continuous mesh tube which is used to produce bags for vegetable and fruit products and similar products, and the tube obtained by means of said process, the tube of which is made up of four strips, two laminated strips and two other mesh strips, all of which are arranged in alternating positions, partially overlapping along bands connected to one another. The tube additionally has four reinforcement bands located near both free ends of each of the mesh strips, being connected to their inner face and to the laminated strips by means of gluing.

### FIELD OF THE INVENTION

The present invention relates to improvements introduced in invention patent number 200102600 relating to a process for obtaining a continuous mesh tube which is used to produce bags for vegetable and fruit products and similar products, especially applied for obtaining a continuous tube which transversely alternates cross-linked mesh strips with plastic strips and reinforcement bands located on the inner face of said tube which act, together with the mentioned laminated, as reinforcement and support for different types of graphic prints.

### BACKGROUND OF THE INVENTION

Different types of bags intended for containing vegetable and fruit products such as oranges, lemons, potatoes, etc. are already known on the market and are usually formed from a continuous extruded mesh tube which is filled with the mentioned products and subsequently closed in the packaging process.

The tube obtained by means of the process described in patent number 200102600 is formed from four longitudinal strips, two lateral mesh strips and two plastic laminated strips, which are all arranged in alternating positions being partially overlapped, the laminated strips specifically being located outside the lateral mesh strips. The laminated strips and the lateral mesh strips were connected by means of heat-welding; this manufacturing process has the following drawbacks:
The heat applied for the mentioned connection occasionally wrinkles the laminated strip and deforms the graphic prints and make the letters illegible.
The process is limited to the use of certain materials for the mesh strips and the laminated strips because in order for the safe connection of the materials to occur it is necessary for both of them to have similar melting points, and therefore the connection of different types of materials and with different melting points, such as polypropylene, polyethylene, paper, etc., for example, is not allowed.
The tube production rate is rather slow because it is necessary to wait for the melted material to cool down in order to be able to handle the tube without causing deformations.

The objective of these improvements is to solve the problems set forth, making it possible to connect the laminated strips and the lateral mesh strips by means of simple gluing as well as by means of heat-welding, to which end it is necessary to introduce additional bands located on the inner face of the free ends of the lateral mesh strips, the main purpose of which is to reinforce the connection between the laminated strips and the lateral mesh strips.

### DESCRIPTION OF THE INVENTION

The present invention relates to improvements introduced in invention patent number 200102660 relating to a process for obtaining a continuous mesh tube which is used to produce bags for vegetable and fruit products and similar products, and the tube obtained by means of said process, which tube is formed by four strips, two laminated strips and two other mesh strips, all of which are arranged in alternating positions, partially overlapping along bands connected to one another, providing in addition to the mentioned laminated strips four reinforcement bands located near both free ends of each of the mesh strips being connected to their inner face and to the laminated strips.

It is therefore achieved that there is no deformation of the laminated strips since they do not have to be heating for connecting them to the mesh strips; different materials can be used in the manufacture of the tube, such as paper with polypropylene or polyethylene, and the tube manufacture rate is furthermore considerably increased.

Said connection of the reinforcement strips to the inner face of the mesh strips and to the laminated strips is preferably carried out by means of gluing. It can also be carried out by means of high frequency welding.

As a result of the described configuration, a sandwich arrangement is defined in each of the four connections existing in the tube formed by three layers: a first layer formed by the end of the corresponding laminated strip, an intermediate layer formed by the end of the mesh strip and a third layer formed by the corresponding band; said arrangement makes the bags formed from the tube defined in the present invention to be very strong and it causes greater verticality or rigidity of the tube, making the storage of bags filled with products safer and more stable.

In addition, the placement of the reinforcement bands in coincidence with the handle that each bag incorporates makes the fixing of said handles firmer than if they were only connected to the laminated strips, thus preventing said handles from becoming detached during transport of the bags and therefore preventing the transported product from being damaged.

### BRIEF DESCRIPTION OF THE DRAWINGS

The makeup, form of assembly and improved advantages introduced in invention patent number 200102600 relating to a process for obtaining a continuous mesh tube which is used to produce bags for vegetable and fruit products and similar products, and the tube obtained by means of said process object of the present invention, are explained below in greater detail in the attached drawings which aid in better understanding the invention and which are expressly related to embodiments of said invention that are presented as illustrative and non-limiting examples thereof.

FIG. 1 shows a cross-sectional view of the tube object of the present invention.

FIG. 2 shows a plan, side schematic view of the facility for manufacturing the tube object of the present invention.

FIG. 3 shows a side schematic view of the facility for manufacturing the tube object of the present invention.

### DESCRIPTION OF AN EMBODIMENT OF THE INVENTION

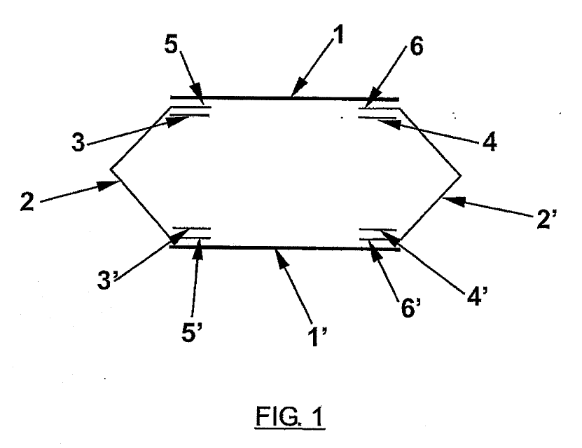

As can be seen in FIG. 1, the improved continuous mesh tube which is used to produce bags for vegetable and fruit products object of the present invention is formed from four strips: two laminated strips 1-1′ and two other mesh strips 2-2′, all of which are arranged in altering positions, partially overlapping along bands connected to one another.

In addition to the four mentioned strips, the tube has four reinforcement bands 3-3′ and 4-4′ located near both free ends of the mesh strips, specifically bands 3 and 3′ are located at the free ends of mesh strip 2 and bands 4 and 4′ on the free ends of mesh strip 2′, being connected to their inner face and at the same time to the laminated strips 1-1′.

Said laminated strips 1-1′ will each be arranged on the free ends of the two mesh strips 2-2′ by means of glue, i.e. laminated strip 1 will be placed on the ends 5 and 6 of the mesh strips 2-2′ respectively, and laminated strip 1′ will be placed on ends 5′ and 6′ of mesh strips 2-2′ respectively; FIG. 1 clearly shows the described arrangement.

Four connections coinciding with the position of the mentioned reinforcement bands 3-3′ and 4-4′ are thus defined with the mentioned arrangement, which bands are arranged longitudinally with regard to the casing of the tube. In each one of the mentioned connections there will be a three-layered structure formed by an outermost layer made up of the ends of the laminated strips, by an intermediate layer made up of the ends of the mesh strips, and by an innermost layer made up of the reinforcement bands.

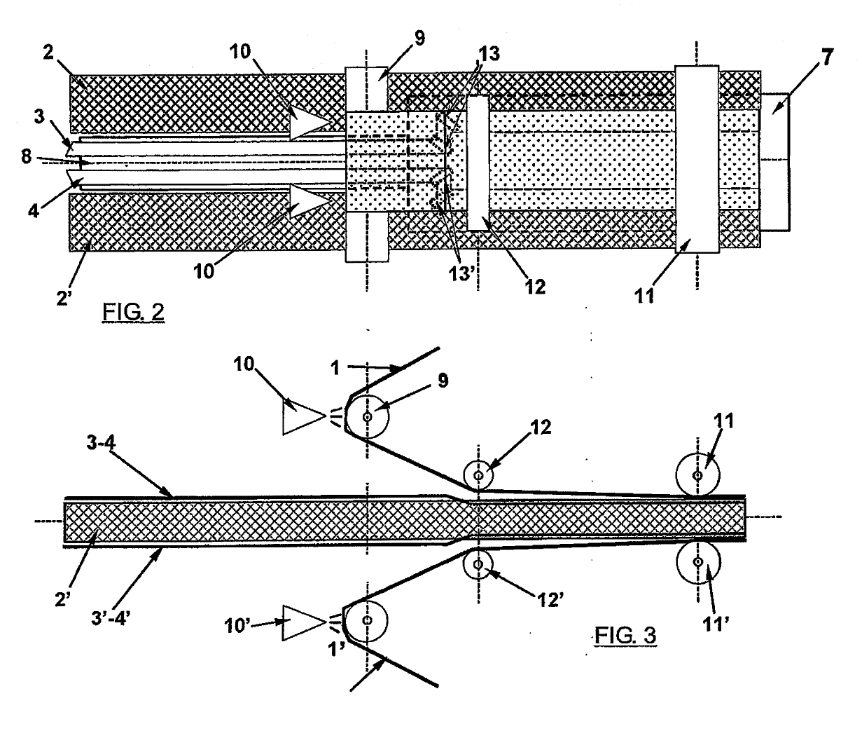

With regard to the facility for manufacturing the improved tube, as can be seen in FIGS. 2 and 3, mesh strips 2-2′ are used to start, which strips can be obtained in two ways: either from two strips which are bent in the shape of a C, or from a closed mesh tube which is cut into two equal portions defining two likewise C-shaped semi-tubes.

At the beginning of the facility, the mesh strips 2-2′ are put on a plate 7 forming part of the mounting, surrounding the edges of said plate so that the strips can continue to be C-shaped; the reinforcement bands 3 and 4 for their part are initially located on a second narrower plate 8 connected to the previous plate such that they are arranged inwardly from the mesh strips; bands 3 and 4 are above the mentioned second plate 8 and bands 3′ and 4′ are under said plate.

Respective rollers 9-9′ are subsequently arranged a certain distance from the mounting through which the laminated strips 1 and 1′ pass, respectively; in that instant four glue applicators, two applicators 10 located above the tube and two applicators 10′ below it, apply glue on the inner face of the laminated strips 1-1′, respectively.

The bands, which will at first run outside the mesh strips, as can be seen in FIG. 2, will then, as a result of respective pairs of eyelets 13-13′ made on the plate 7 (made at 45° in this case) and shown in the figure by means of a disruption in the path of the mentioned bands, be located right under the innermost face of the mesh strips (in order to simplify the drawing, FIG. 2 only shows a pair of bands 3 and 4 with their corresponding parallel eyelets at 45°).

Each of the laminated strips 1-1′ is led to pressure rollers 11-11′, respectively, by means of intermediate rollers 12-12′ tensing said laminated strips; said pressure rollers press each laminated strip, the inner face of which is previously impregnated with glue, against the corresponding mesh strip and in turn against the reinforcement bands located under the free ends of each laminated mesh, achieving that the connection reinforced by the mentioned bands is carried out between the laminated strips and the free ends of the mesh strips, defining a very strong closed tube, the sides of which are made of normally extruded mesh and the front ends of which are made of a laminated strip which can be printed on with commercial and informative motifs.

The connection obtained between the laminated strips and the mesh strips is very strong due to the fact that the mesh strip is located in an intermediate position between the corresponding laminated strip and the reinforcement band, and due to its mesh structure, the glue deposited on the laminated layer passes through the holes of the mesh strip and reaches the band, connecting the three layers in a single pressure-application step by means of the pressure rollers 11-11′, defining a sandwich-type structure in which the mesh strip layer is retained between the corresponding laminated strip layer and the layer formed by the reinforcement band.

1. A continuous mesh tube, of the type used to produce bags for vegetable and fruit products and similar products, comprising: a tube made up of four strips, two laminated strips and two other mesh strips, all of which are arranged in alternating positions, partially overlapping along bands connected to one another, characterized in that four reinforcement bands located near both free ends of each of the mesh strips are additionally arranged, being connected to their inner face and to the laminated strips.

2. Improvements introduced in invention patent number 200102600 according to claim 1, said connection between the inner face and the laminated strips is carried out by means of gluing.

3. Improvements introduced in invention patent number 200102600 according to claim 1, said connection between the inner face and the laminated strips is carried out by means of high frequency welding.
